(19) United States
(12) Patent Application Publication
(10) Pub. No.: US 2014/0117667 A1
(43) Pub. Date: May 1, 2014

(54) MARINE CURRENT POWER PLANT AND A METHOD FOR ITS OPERATION

(71) Applicant: Voith Patent GmbH, Heidenheim (DE)

(72) Inventors: Benjamin Holstein, Heidenheim (DE); Norman Perner, Neu-Ulm (DE)

(73) Assignee: VOITH PATENT GMBH, Heidenheim (DE)

(21) Appl. No.: 14/147,949

(22) Filed: Jan. 6, 2014

Related U.S. Application Data
(63) Continuation of application No. PCT/EP2012/002764, filed on Jul. 2, 2012.

(30) Foreign Application Priority Data
Jul. 6, 2011 (DE) 10 2011 107 286.5

(51) Int. Cl. F03B 13/10; F03B 15/00

(52) U.S. Cl. CPC F03B 13/10; F03B 15/00
USPC 290/43

(57) ABSTRACT

The invention relates to a method for operating a marine current power plant, comprising a water turbine with several rotor blades arranged as buoyancy rotors, an electric generator which is driven at least indirectly by the water turbine, wherein the water turbine is guided for power limitation in an overspeed range above a power-optimal tip speed ratio. The water turbine is adjusted to the immersion depth of the marine current power plant in such a way that cavitation occurs on at least one rotor blade section in the overspeed range from a cavitation tip speed ratio threshold which lies below a tip speed ratio associated with a runaway speed, and the water turbine is operated for load limitation at tip speed ratios which lie above the cavitation tip speed ratio threshold.

### CROSS REFERENCE TO RELATED APPLICATIONS

This is a continuation of PCT application No. PCT/EP2012/002764, entitled “A MARINE CURRENT POWER PLANT AND A METHOD FOR ITS OPERATION”, filed Jul. 2, 2012, which is incorporated herein by reference.

### BACKGROUND OF THE INVENTION

1. Field of the Invention

The invention relates to a marine current power plant which is especially used as a tidal power plant, and a method for its operation.

2. Description of the Related Art

Marine current power plants are known which comprise propeller-shaped water turbines arranged as buoyancy rotors combined with an electric generator, which are driven as freestanding units by the flow of a water body. An axial turbine design with a horizontal rotational axis is preferred in the present case. The use of such marine current power plants for power generation from a water course or a marine current can be considered at locations where no extensive barrages can be erected. A water turbine with a profile that can use bidirectional inflows can be used for power generation from tides, or the marine current power plant can be adjusted automatically in its entirety during the change in the direction of a current.

Without the locking mechanisms that are typically provided in dam structures in the flow channels leading to the water turbine there is no possibility for decoupling from the ambient flow for generic marine current power plants in the case of an overload. Accordingly, measures must be taken for the protection of the installations in the event of strong inflow.

One possibility for the down-regulation of the power and load is to provide the water turbine with rotor blades that are rotatably fixed to a hub part. The rotor blades are guided to the feathering pitch for down-regulation. The rotatable rotor blade holder required for this purpose is complex from a constructional standpoint, especially for the large-size installations that are necessary for efficient power generation from currents that flow slowly. Furthermore, the bearing components and actuators required for setting the blade angle as well as the relevant control unit represent a source of increased failure risk. Since generic installations will typically be immersed completely, maintenance of the installation is difficult so that a simplified installation concept with rotor blades linked in a torsionally rigid manner will lead to an installation with a longer operational lifespan.

An alternative measure for down-regulation, which is especially used for water turbines with rotor blades fixed in a torsionally rigid manner, is operating the marine current power plant with a tip speed ratio above the power-optimal tip speed ratio. Reference is hereby made by way of example to DE 10 2008 053 732 B3. The tip speed ratio represents the ratio between the blade tip speed and the inflow velocity averaged over the rotor circle.

The overspeed range used for down-regulation reaches from the power-optimal tip speed ratio up to a tip speed ratio associated with the runaway speed, for which the braking generator torque will be cancelled. In this respect, the tip speed ratios used for down-regulation in strong inflow can lead to centrifugal forces which exert a strong load on the installation. The power absorbed by the water turbine for high tip speed ratios will be reduced effectively. However, the thrust forces absorbed by the water turbine will not decrease to the same extent. Consequently, there is a thrust coefficient in the runaway speed for which critical thrust loads can act on the installation in the case of a further increase in the average inflow speed.

What is needed in the art is a marine current power plant and a method for the operation of a water turbine in the overspeed range which can produce effective down-regulation concerning the power and the loads, especially the axial thrust load, already at low tip speed ratios. In particular, there is a need for down-regulation that occurs for a tip speed ratio which lies sufficiently beneath the tip speed ratio associated with the runaway speed.

### SUMMARY OF THE INVENTION

The invention is based on a generic marine current power plant, especially a tidal power plant. This relates to a marine current power plant which comprises a water turbine with several rotor blades which are arranged as a buoyancy rotor, e.g. a horizontal rotor turbine. The water turbine drives an electric generator at least indirectly, but a direct drive is more common, i.e. a torsionally rigid coupling of the electric generator with the water turbine via a drive shaft. Alternatively, the coupling between the electric generator and the water turbine can occur indirectly, e.g. via an interposed hydrodynamic coupling.

Accordingly, an embodiment is provided for which the generator torque generated by the electric generator acts in a braking manner on the water turbine, wherein the load current for adjusting the stator voltage components (d, q) of the electric generator can be set by an open-loop or closed-loop control unit and therefore for predetermining a specific generator torque. This control apparatus for the electric generator is realized, for example, by means of a frequency converter, which comprises an intermediate DC circuit, a rectifier on the generator side and an inverter on the mains side for mains connection of the electric generator. The rectifier on the generator side predetermines the load current on the generator stator.

For the purpose of limiting the power taken from the flow, the water turbine is down-regulated from a predetermined nominal power by guidance into the overspeed range. For this purpose, the tip speed ratio λ of the water turbine is shifted towards higher values in relation to the power-optimal tip speed ratio λₒₚₜ. The tip speed of the water turbine can be performed in this process up to the runaway speed, for which only the frictional losses will act as braking torques on the water turbine, which means the generator torque will be cancelled completely. The runaway speed depends on the mean inflow speed, wherein a tip speed ratio λ_{d} remains substantially constant.

In accordance with the invention, the down-regulation of a generic marine current power plant is carried out in a range which is sufficiently distanced from the tip speed ratio λ_{d} associated with the runaway speed in the direction towards lower tip speed ratios λ. This leads to a safety reserve until the water turbine is released by complete removal of the generator torque. For this purpose, the characteristics of the water turbine are adjusted in accordance with the invention to the operation under cavitation, since the power coefficient and thrust coefficient curves will decrease steeply upon occurrence of cavitation with rising tip speed ratio λ.

The water turbine will be adjusted to the immersion depth of the marine current power plant in such a way that in the overspeed range, i.e. above a power-optimal tip speed ratio λₒₚₜ, a cavitation tip speed ratio threshold λₖ is determined, which is sufficiently beneath the tip speed ratio λ_{d} which is associated with the runaway speed. Load limiting means are thus provided in a control apparatus which set the tip speed ratio λ for the water turbine in such a way that, in the case of a strong inflow, a value for λ above the cavitation tip speed ratio threshold λₖ will follow. This leads to the following:

As a result of the abrupt drop in the power coefficient of the water turbine upon occurrence of cavitation, down-regulation will already occur at relatively low tip speed ratios λ, so that lower centrifugal forces need to be caught in the revolving unit of the marine current power plant. As a result, relatively high tip speed ratios λ can be used, i.e. in the power-optimal operation with the power-optimal tip speed ratio λₒₚₜ, thus leading to simplified bearing. Slide bearings can be used in particular. Furthermore, sufficiently high rotational speeds in power-optimal operation allow a compact electric generator.

Heavy inflow conditions, in which the water turbine revolves in the cavitation range, lead to high blade tip speeds. Sound is produced during the explosion of the cavitation bubbles which keeps marine life away from the rotor blades which revolve rapidly in this case. Furthermore, cavitation removes maritime growth on the rotor blades.

Down-regulation of the marine current power plant preferably relates to a limitation in the thrust force of the water turbine in the direction of rotation in addition to the limitation of the power taken up by the water turbine. The thrust force on the rotor can be reduced above a predetermined low threshold by shifting towards higher tip speed ratios λ. The strong drop in the thrust coefficient C_{F} on occurrence of the cavitation which is the result of the rotor characteristics in accordance with the invention will be utilized in accordance with the invention. Otherwise, substantially higher rotational speeds are required for the down-regulation, so that there is a likelihood that the runaway speed is reached, wherein in this case a further increase in the mean inflow speed will successively increase the thrust load entered by the water turbine.

For the purpose of cavitation-proof configuration of the rotor, the parts of the rotor blade which are affected by cavitation will be provided with a protective coating. An elastomeric material can be applied for this purpose. Cavitation-proof covers such as plastic elements can be anchored as an alternative on the load-bearing structures at locations on the rotor blade surface on which cavitation is expected. The rotor characteristics are adjusted to the immersion depth in such a way that the cavitation is locally limited to the blade tip region. The region of the rotor blade is preferred on which cavitation can occur at a position at the apex of the rotor circle, limited to the radially outer third of the longitudinal extension of the blade.

### BRIEF DESCRIPTION OF THE DRAWINGS

The above-mentioned and other features and advantages of this invention, and the manner of attaining them, will become more apparent and the invention will be better understood by reference to the following description of (an) embodiment(s) of the invention taken in conjunction with the accompanying drawing(s), wherein:

FIG. 1 shows an exemplary progression of the power coefficient for the water turbine of a marine current power plant in accordance with the invention in comparison with an arrangement according to the state of the art;

FIG. 2 shows a marine current power plant in accordance with the invention;

FIG. 3 shows a marine current power plant in accordance with the invention with down-regulation of the power and the load.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

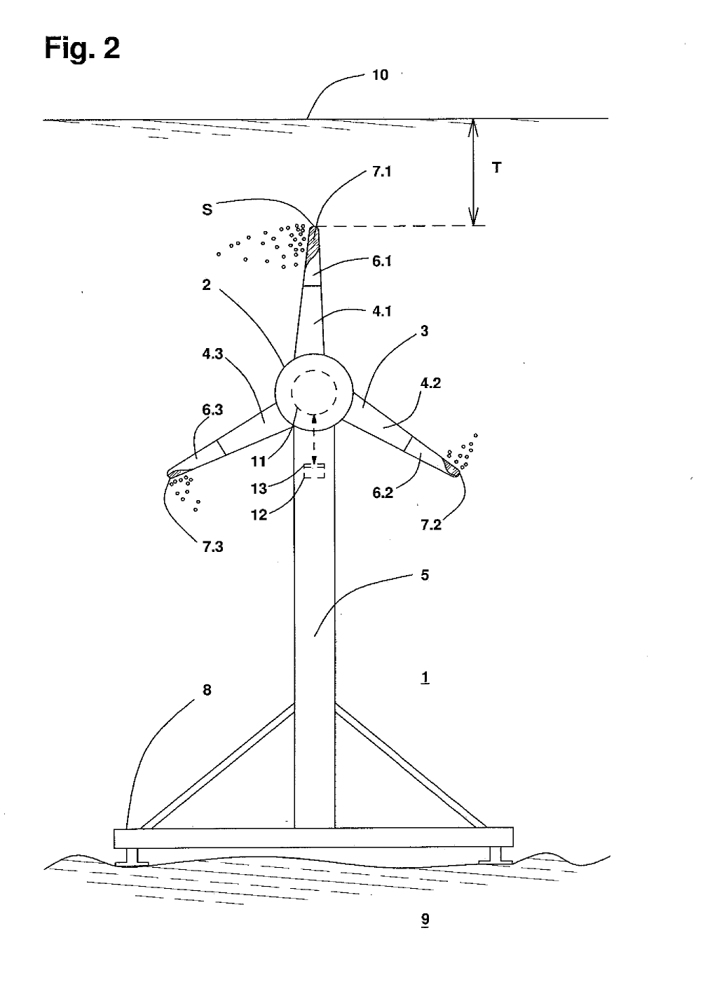

FIG. 2 shows a schematic simplified view of a marine current power plant 1 in accordance with the invention, which is supported on the ground 9 of a water body via a tower 5 and a gravity foundation 8. The marine current power plant 1 is completely situated beneath the water surface 10.

The revolving unit 2 of the marine current power plant 1 includes a propeller-shaped water turbine 3 with three rotor blades 4.1, 4.2, 4.3. Each rotor blade 4.1, 4.2, 4.3 includes on the radially outer half a cavitation-proof coating 6.1, 6.2, 6.3, which is arranged as an elastomeric coating. Furthermore, an electric generator 11 can be connected in a torsion-proof way to the water turbine 3. The electric generator 11 is associated with a control device 12 which is used for setting the generator torque. The speed guidance of the water turbine 3 occurs on the basis of a predetermined tip speed ratio λ. The control apparatus 12 includes load limiting means 13 for setting tip speed ratios λ up to and above a cavitation tip speed ratio threshold λₖ.

FIG. 2 further shows the marine current power plant in accordance with the invention during operation in the overspeed range, which means for a tip speed ratio λ above the power-optimal tip speed ratio λₒₚₜ in the case of strong inflow. Cavitation bubbles form at the tips of the rotor blades 4.1, 4.2, 4.3 in the rotor blade sections 7.1, 7.2, 7.3. The cavitation is most distinct when passing through an apex S and has the maximum spatial expansion on the respective rotor blade 4.1, 4.2, 4.3. The rotor characteristics are arranged depending on the immersion depth T of the marine current power plant 1 in such a way that the cavitation is limited to the region of the cavitation-proof coating 6.1, 6.2, 6.3.

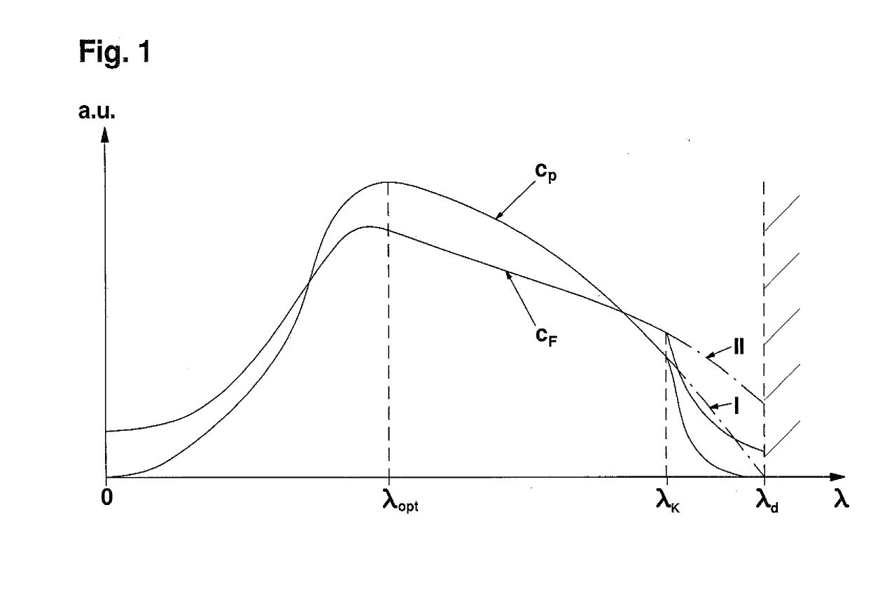

FIG. 1 shows the effect of the water turbine 3 configured for cavitation operation. The illustration shows the curve of the power coefficient cₚ and the thrust coefficient c_{F} in relation to the tip speed ratio λ. The power coefficient cₚ is calculated from the power P absorbed by the water turbine 3, the density ρ of the flow medium, the averaged inflow velocity v and the rotor radius r as follows:

$${c}_{p} = \frac{P}{\frac{1}{2} \cdot ρ \cdot {v}^{3} \cdot π \cdot {r}^{2}}$$

The power coefficient cₚ has a maximum for a power-optimal speed ratio λₒₚₜ.

Furthermore, the thrust coefficient c_{F} is determined from the thrust force F in the direction of the rotational axis of the water turbine 3, the density p of the flow medium, the averaged inflow speed v and the rotor radius r as follows:

$${c}_{F} = \frac{F}{\frac{1}{2} \cdot ρ \cdot {v}^{2} \cdot π \cdot {r}^{2}}$$

The continuous curves in FIG. 1 represent the characteristics of the water turbine 3 according to an embodiment in accordance with the invention. There is a cavitation tip speed ratio threshold λₖ, above which cavitation occurs. The illustration shows a strong drop in the power coefficient cₚ and the thrust coefficient c_{F} for tip speed ratios λ above the cavitation tip speed ratio threshold λₖ. A respective drop is not present in a water turbine 3 without the occurrence of cavitation. This is shown by way of dot-dash curves I and II for a water turbine not arranged for cavitation operation. They show considerably higher power coefficients cₚ and thrust coefficients c_{F}, so that the down-regulation of a non-cavitation marine current power plant leads to substantially higher tip speed ratios λ in the range of the tip speed ratio λ_{d} associated with the runaway speed n_{d} in comparison with the embodiment in accordance with the invention. A water turbine can be used where the rotor design, and the chosen rotor profile in particular, is arranged in relation to the immersion depth in such a way that the following applies to the cavitation tip speed ratio threshold λₖ: λₖ<0.9 λ_{d}, and especially preferably λₖ<0.8 λ_{d}.

As a result of the cavitation effects utilized in accordance with the invention, down-regulation already occurs at relatively low tip speed ratios λ, so that the system can operate at a sufficiently high power-optimal speed ratio λₒₚₜ. This allows normal operation of the installation with a rapidly running water turbine 3, thus simplifying the configuration of the bearing and allowing for a compact size of the electric generator.

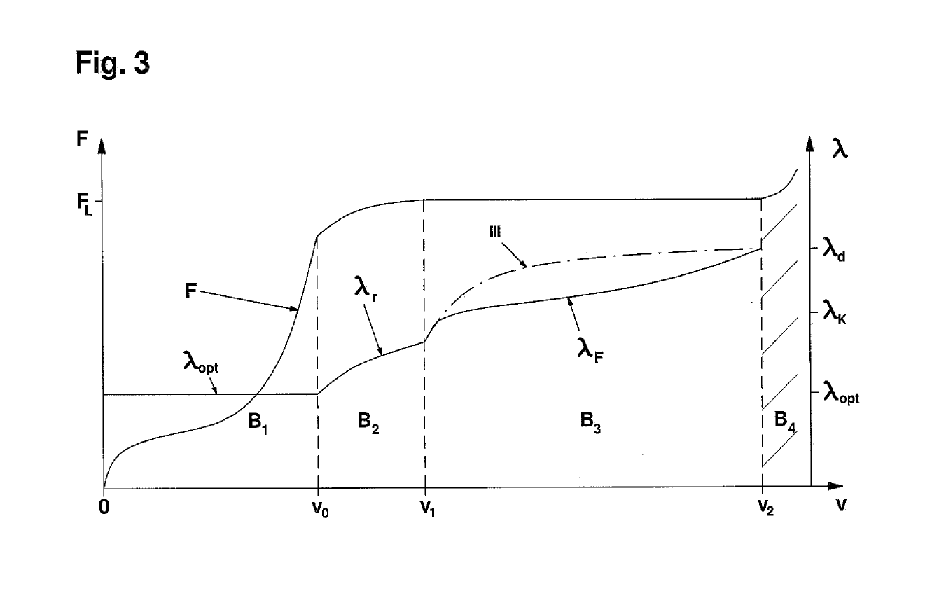

FIG. 3 shows the load curve on the basis of the axial thrust load F against an averaged inflow velocity v for a marine current power plant 1 in accordance with the invention. The water turbine 3 operates at a power-optimal speed ratio λₒₚₜ in a first power-optimal operating range B1. Upon reaching the normal power at the averaged inflow velocity v₀ there will be a transition to the power-limited operating range B₂, during which a power-limited tip speed ratio λᵣ will be used. A further change in the operating state is performed at a predetermined thrust load threshold F_{L}, during which the water turbine will be guided on the basis of a predetermined curve for a load-limited tip speed ratio λ_{F} and therefore in a thrust-load-limited operating range B₃. As a result, a down-regulation of the installation for strong inflow occurs with respect to the thrust load F with an averaged inflow velocity v above v1.

An averaged inflow velocity v above v₂ represents a range for which the runaway speed N_{d} has been reached. Accordingly, the tip speed ratio λ remains on a constant tip speed ratio λ_{d} which is associated with the runaway speed n_{d}. Accordingly, an increase in the averaged inflow velocity v in the overload range B₄ leads to a renewed increase in the thrust load F which can exceed the configuration of the installation. That is why effective down-regulation should be achieved already for sufficiently low tip speed ratios λ in the preceding load-limited operating range B₃. Such down-regulation follows from the cavitation operation in accordance with the invention along the continuous curve in the load-limited operating range B3 for the set load-limited tip speed ratio λ_{F}. In contrast, the dot-dash curve III indicates the progression without the occurrence of cavitation.

Further embodiments of the invention can be considered within the scope of the following claims, wherein the invention can also be applied to vertical axial rotors in addition to the horizontal rotors as illustrated above. Furthermore, embodiments with a jacket turbine can also be considered.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

1 Marine current power plant
2 Revolving unit
3 Water turbine
4.1, 4.2, 4.3 Rotor blade
5 Tower
6.1, 6.2, 6.3 Cavitation-resistant coating
7.1, 7.2, 7.3 Rotor blade
8 Gravity foundation
9 Ground of water body
10 Water surface
11 Electric generator
12 Control apparatus
13 Load limiting means
cₚ Power coefficient
c_{F} Thrust coefficient
nₖ Runaway speed
λ Tip speed ratio
λₒₚₜ Power-optimal tip speed ratio
λₖ Cavitation tip speed ratio threshold
λ_{d} Tip speed ratio associated with runaway speed
λ_{F} Load-limited tip speed ratio
λᵣ Power-limited tip speed ratio
B₁ Power-optimal operating range
B₂ Power-limited operating range
B₃ Load-limited operating range
B₄ Overload range

What is claimed is:

1. A method for operating a marine current power plant, comprising the steps of:
providing a water turbine with a plurality of rotor blades arranged as buoyancy rotors;
driving an electric generator at least indirectly by said water turbine;
guiding said water turbine for power limitation in an overspeed range above a power-optimal tip speed ratio;
adjusting said water turbine to an immersion depth of the marine current power plant so that cavitation occurs on at least one rotor blade section in the overspeed range from a cavitation tip speed ratio threshold which lies below a tip speed ratio associated with a runaway speed; and
operating said water turbine for load limitation at tip speed ratios which lie above the cavitation tip speed ratio threshold.

2. The method according to claim 1, wherein the tip speed ratio is set for load limitation by one of the control and feedback control of a generator torque braking said water turbine.

3. The method according to claim 1, wherein said at least one rotor blade section on which cavitation occurs is spatially limited for the tip speed ratios adjustable for limiting the load.

4. The method according to claim 3, wherein said at least one rotor blade section on which cavitation occurs is limited to a radially outer third of a longitudinal extension of at least one of said plurality of rotor blades.

5. The method according to claim 4, wherein the tip speed ratio associated with the runaway speed is reached for an inflow which exceeds a maximum inflow the power plant is configured to operate with.

6. A marine current power plant, comprising:
a water turbine with a plurality of rotor blades arranged as buoyancy rotors, said water turbine configured so that at an immersion depth of said marine current power plant cavitation occurs on at least one rotor blade section in an overspeed range from a cavitation tip speed ratio threshold which lies below a tip speed ratio associated with a runaway speed;
an electric generator which is configured to be driven at least indirectly by said water turbine; and
a control apparatus for said electric generator including a load limiter for setting tip speed ratios for the water turbine which lie above the cavitation tip speed ratio threshold, said control apparatus guiding said water turbine to an overspeed range above a power-optimal tip speed ratio.

7. The marine current power plant according to claim 6, wherein said plurality of rotor blades comprise at least one of a cavitation-resistant coating or at least one cavitation-resistant component.

8. The marine current power plant according to claim 7, wherein said cavitation-resistant coating comprises an elastomeric layer.

9. A marine current power plant according to claim 8, wherein at least one of said cavitation-resistant coating or said at least one cavitation-resistant component is present on a radially outer third of a longitudinal extension of said at least one of said plurality of rotor blades.
